(19) United States
(12) Patent Application Publication
(10) Pub. No.: US 2026/0198525 A1
(43) Pub. Date: Jul. 16, 2026

(54) MEAT-ANALOGUE COMPOSITION COMPRISING LINOLEIC ACID AND a-LINOLENIC ACID RESIDUES

(71) Applicant: AAK AB (PUBL), Malmö (SE)

(72) Inventor: Margarete Rosa KERFERS, Malmö (SE)

(21) Appl. No.: 19/137,716

(22) PCT Filed: Dec. 15, 2023
(86) PCT No.: PCT/SE2023/051273

§ 371 Date: Jun. 11, 2025

(30) Foreign Application Priority Data
Dec. 15, 2022 (SE) 2230417-4

(51) Int. Cl. A23J 3/22; A23D 7/005; A23L 33/105; A23L 33/12

(52) U.S. Cl. CPC A23J 3/227; A23D 7/0053; A23L 33/105; A23L 33/12

(57) ABSTRACT

Disclosed herein is a meat analogue composition comprising a meat analogue composition comprising from 2% to 81% by weight of a fat composition; from 1% to 30% by weight of a non-animal protein; and from 18% to 70% by weight of water; wherein the fat composition comprises from 20% to 85% by weight of saturated fatty acid residues; from 5% to 50% by weight of stearic acid residues (C18:0); from 2 to 35% by weight of linoleic acid residues (C18:2); and from 1 to 15% by weight of α-linolenic acid residues (C18:3); from greater than 10 to 35% by weight of lauric acid residues (C12:0); wherein said percentages of fatty acid residues refers to fatty acids bound as acyl groups in glycerides in the fat composition and being based on the total weight of C6 to C24 fatty acid residues bound as acyl groups present in the fat composition.

### FIELD OF THE INVENTION

The invention relates to meat analogue compositions comprising a fat composition, non-animal protein and water, and the use of said meat analogue compositions in food products. In particular, the invention relates to the use of said fat compositions in meat analogue compositions to improve various properties of the meat analogue compositions.

### BACKGROUND OF THE INVENTION

There is an increasing demand for plant-based foods due to consumer's increasing desire to eat healthy, sustainably sourced food products and to generally lower their meat intake. This has led to the development of meat-analogues; meat-free, vegetarian or vegan food products which mimic certain qualities of meat or meat-based products, such as the texture, taste and/or appearance.

Many different types of meat-analogues are available, such as those based on tofu, lentils and beans, some of which aim to mimic meat completely in terms of sizzling and browning during cooking, bleeding, colour, texture and taste. One example of such meat-analogues is plant-based burgers. Products such as plant-based sausages, meat balls, meat loaf and nuggets are also known in the art.

The typical composition of known meat-analogues is 50 to 70% water, 10 to 25% proteins (such as soy, pea, potato and wheat), 5 to 20% fat, 0 to 10% carbohydrates, as well as flavourings and colourings. Various fats have been proposed for use in meat analogue compositions. It is important that the fat is not an animal-derived fat such that the meat analogue composition is suitable for consumption by vegetarians and vegans. Accordingly, animal fats that are typically solid at room temperature are generally not used in meat analogue compositions. In order to produce a desirable meat-analogue, it is important that the final products have an appealing taste, texture and mouthfeel, and have similar taste, texture and mouthfeel to meat. Such properties are generally affected by the nature of the fat included in the meat analogue composition. The nature of the fat in meat analogue compositions also typically has an effect upon juiciness of the compositions and upon flavour release as the fats often function as carriers for fat soluble flavours. The nature of the fat is also important for the processability of the meat analogue such as during moulding of a meat analogue composition into burger patties. The nature of the fat is also important for providing visual similarity to meat products.

Coconut oil, palm oil, sunflower oil and rapeseed oil are examples of conventional vegetable derived fats that have been proposed for use in meat analogue compositions. It is desirable that the fats have a relatively high melting point in order to mimic effects such as the taste, texture and mouthfeel of high melting point animal fats found in meats which are typically solid at room temperature. As a result, coconut oil and palm oil have attracted attention as they have relatively high melting points compared to other vegetable oils. Of these oils, coconut oil is typically preferred due to the negative environmental effects associated with the production of palm oil. Furthermore, palm oil contains a high amount of palmitic acid residues which is considered to be detrimental to cholesterol levels of consumers. A problem with both coconut oil and palm oil is that they are high in saturated fatty acids, which is generally considered less attractive from a nutritional aspect. The use of alternative oils lower in saturated fatty acid residues such as sunflower oil and rapeseed oil has been found to compromise desirable properties of meat analogue compositions due to the liquid nature of the oils. Properties such as juiciness are compromised, and the liquid nature of the oils means that there is no structuring potential of the meat analogue composition resulting in oily meat doughs which create problems during moulding and processing of the meat analogue compositions. As a result, coconut oil remains the industry standard for the fat used in meat analogue compositions.

The inventors of the present invention have appreciated that there are various disadvantages of using coconut oil in meat analogue compositions. Firstly, as discussed above, coconut oil is high in saturated fatty acid residues which is undesirable for consumers from a health perspective due to the association of saturated fatty acid residues in fats with heart disease, undesirable cholesterol levels, and related conditions. The inventors of the present invention have also appreciated that coconut oil, despite having a relatively high melting point for a vegetable oil, has a steep melting curve. In other words, at colder temperatures of less than 15° C., coconut oil is a hard brittle solid, whereas at higher temperatures of 30° C. to 35° C., the coconut oil is a liquid containing no or very little solid fat. It has been found by the inventors that the solid, hard brittle structure of coconut oil at lower temperatures means that the coconut oil is often difficult to process and sufficiently mix in with other components of the meat analogue composition during manufacture, meaning that it is sometimes desirable for the coconut oil to be melted or heated beforehand. This is undesirable in manufacturing processes due to the extra energy required to melt the coconut oil during manufacture and due to the subsequent temperature increase of the other components. The temperature increase might lead to a microbial growth increase and to a reduction of the hydration of certain ingredients.

An additional disadvantage associated with the use of coconut oil is that its steep melting curve means that there is only a narrow temperature window in which coconut oil can be mixed into a meat analogue composition as a solid. It has also been found that having no solid fat at 30° C. to 35° C. is undesirable since this results in an overly quick release of fat/flavour from the meat analogue compositions. Many flavours present in meat analogue compositions are fat soluble and so are released overly quickly on melting of the fat. A further disadvantage of coconut oil is that it often contains high levels of mineral oil saturated hydrocarbons (MOSH) and mineral oil aromatic hydrocarbons (MOAH).

There remains a need for providing a meat analogue composition that solves or alleviates many of the problems discussed above such as to mimic the meat fat present in meat products. In particular, it would be especially convenient to provide a healthier meat analogue composition, i.e. having notably an improved nutritional profile including a lower content of saturated fatty acids decreasing the risks of heart disease, high blood pressure and high level of cholesterol; when compared to conventional fats usually used in meat analogue compositions including notably coconut oil. Furthermore, it would be also convenient to provide a meat analogue composition having an improved mouthfeel and an improved processability when compared to said conventional fats.

### SUMMARY OF THE INVENTION

According to a first aspect of the invention, there is a meat analogue composition comprising from 2% to 81% by weight of a fat composition; from 1% to 30% by weight of a non-animal protein; and from 18% to 70% by weight of water; wherein the fat composition comprises from 20% to 85% by weight of saturated fatty acid residues; from 5% to 50% by weight of stearic acid residues (C18:0); from 2 to 35% by weight of linoleic acid residues (C18:2); and from 1 to 15% by weight of α-linolenic acid residues (C18:3); from greater than 10 to 35% by weight of lauric acid residues (C12:0); wherein said percentages of fatty acid residues refer to fatty acids bound as acyl groups in glycerides in the fat composition and being based on the total weight of C6 to C24 fatty acid residues bound as acyl groups present in the fat composition.

According to a second aspect of the invention, there is provided a food product comprising a meat analogue composition of the invention. The food product may be an uncooked food product, a cooked food product, or a partially cooked food product.

According to a third aspect of the invention, there is provided the use of a meat analogue composition according to the invention in a food product.

According to a fourth aspect of the invention, there is provided a process of manufacturing a meat analogue composition of the invention or a food product of the invention.

### DETAILED DESCRIPTION OF THE INVENTION

The present invention is based upon the surprising finding that certain fat compositions solve or alleviate many of the problems discussed above when seeking to mimic the animal fat present in meat products. It has been found that the fat compositions according to the present invention have an improved nutritional profile relative to coconut oil. Indeed, as recognized by the World Health Organization and the European Food Safety Organization, intake of saturated fats should be low to avoid any negative impact on health. Moreover, the fat composition according to the present invention has an improved nutritional profile relative to a fat blend comprising (a) an interesterified blend of shea butter and/or shea stearin and coconut oil, and (b) sunflower oil due to higher amounts of α-linolenic acid residues (C18:3) and lower amounts of linoleic acid residues (C18:2). It is believed that the components of the fat composition, in particular the above amounts of omega-3, omega-6 residues and saturated fatty acid residues, may significantly prevent or have a beneficial effect on certain diseases and may decrease the risk of heart disease, high blood pressure and high level of cholesterol.

Furthermore, the inclusion of these fat compositions in meat analogue compositions in place of conventional fats, such as coconut oil, has been found to not negatively affect, and in some cases improve, various properties of meat analogue compositions such as various sensory properties of the compositions. It has been surprisingly found that fat compositions according to the present invention with improved nutritional profile provide improved mouthfeel and improved juiciness to the meat analogue compositions when cooked or partially cooked, in comparison to meat analogue compositions comprising an equivalent amount of coconut oil or liquid oils as sunflower oil. Additionally, the present invention is based upon the surprising finding that the inclusion of the fat compositions according to the present invention in meat analogue compositions has been found to improve various properties of meat analogue compositions, and products formed therefrom, including juiciness and tenderness in comparison to meat analogue compositions comprising an equivalent amount of a blend comprising an interesterified blend of shea butter and/or shea stearin and coconut oil; and sunflower oil.

A further advantage of the certain fat compositions compared to coconut oil is that they can be crystallised in a more ‘plasticised form’ meaning that said compositions are more ‘deformable’ than coconut oil at typical processing temperatures meaning that said fat compositions can be incorporated and mixed into meat analogue compositions more easily. Easier processability and manufacture is thus provided. The ability to admix the fat compositions into meat analogue compositions without melting has also been found useful by the inventors to provide heterogeneity to the surfaces of food products containing the meat analogue compositions meaning that said food products more closely mimic the visual appearance of meat, compared to meat analogue compositions where the fat is melted prior to mixing with the other components of the composition. For example, hard brittle structures of the fat compositions can be provided and mixed into the meat analogue compositions which mimic the effect of “marbling” in meat compositions. Alternatively, plasticised fat structures of crystallised fat can be provided and mixed with other components of a meat analogue composition. The term “fat” as used herein refers to glyceride fats and oils containing fatty acid acyl groups and does not imply any particular melting point. The term “oil” is used synonymously with “fat” herein.

The term “animal meat” herein refers to a meat originated from animal.

The term “fatty acid”, as used herein, refers to straight chain saturated or unsaturated (including mono- and poly unsaturated) carboxylic acids having 6 to 24 carbon atoms. A fatty acid having×carbon atoms and y double bonds may be denoted Cx:y. For example, palmitic acid may denote C16:0, oleic acid may denote C18:1. Percentages of fatty acids in compositions referred to herein include acyl groups in tri-, di- and mono-glycerides present in the glycerides and are based on the total weight of C6 to C24 fatty acids. The fatty acid profile (i.e. composition) may be determined, for example, by fatty acid methyl ester analysis (FAME) using gas chromatography according to IUPAC 2.304.

Triglyceride content may be determined for example based on molecular weight differences (Carbon Number (CN)) by AOCS Ce 5-86. The notation triglyceride CNxx denotes triglycerides having xx carbon atoms in the fatty acyl groups, e.g. CN54 includes tristearin. Amounts of triglycerides specified with each carbon number (CN) as is customary terminology in the art are percentages by weight based on total triglycerides of CN26 to CN62 present in the fat composition.

In one embodiment, the fat composition comprises from 20% to 70% by weight of saturated fatty acids such as from 20% to 60% by weight of saturated fatty acids; preferably from 65% to 85% by weight of saturated fatty acids or from 20% to 65% by weight of saturated fatty acids.

In one embodiment, the fat composition comprises less than 10% by weight of palm oil; preferably, wherein the composition comprises less than 5% by weight of palm oil; more preferably, wherein the composition comprises less than 2% by weight of palm oil; and most preferably wherein the composition does not comprise palm oil.

The fat composition preferably comprises a low amount of palmitic acid. For example, the fat composition comprises 20% by weight or less; preferably 10% by weight or less of palmitic acid (C16:0); and most preferably 5% by weight or less of palmitic acid (C16:0). This is advantageous from a nutritional perspective since palmitic acid is known to increase total cholesterol and LDL cholesterol levels. Typically, the fat composition has a weight ratio of stearic acid (C18:0) to palmitic acid (C16:0) of from 1:1 to 12:1. Typically, the fat composition has a weight ratio of lauric acid (C12:0) to stearic acid (C18:0) of from 1:4 to 4:1. Preferably, the fat composition comprises from greater than 10% to 25% by weight lauric acid (C12:0); and/or from 15% to 45% by weight stearic acid (C18:0).

In one embodiment, the fat composition is a non-hydrogenated fat composition.

Preferably, the fat composition comprises from greater than 10 to 30% by weight of lauric acid residues (C12:0); preferably from greater than 10 to 25% by weight of lauric acid residues (C12:0); more preferably from greater than 10 to 20% by weight of lauric acid residues (C12:0); and advantageously from greater than 10 to 15% by weight of lauric acid residues (C12:0).

Without wishing to be bound by any theory, it is believed that fats with high lauric content are reported as being less likely to accumulate as body fat compared to fats containing a higher proportion of longer chain saturated fatty acids.

Preferably, the fat composition has a weight ratio of linoleic acid residues (C18:2) to α-linolenic acid residues (C18:3) of from 1:1 to 20:1; preferably from 1:1 to 18:1; more preferably between 1:1 and 15:1. In another preferred embodiment, the fat composition has a weight ratio of linoleic acid residues (C18:2) to α-linolenic acid residues (C18:3) of from 1:1 to 10:1; preferably from 1:1 to 8:1; more preferably between 2:1 and 5:1 and advantageously between 3:1 and 4:1. More preferably, the fat composition has a weight ratio of linoleic acid residues (C18:2) to α-linolenic acid residues (C18:3) of from 10:1 to 18:1; preferably from 10:1 to 15:1; more preferably between 11:1 and 13:1. The inventors have found that these ratios of linoleic acid residues (C18:2) to α-linolenic acid residues (C18:3) further improve the nutritional value of the fat composition. It has been found that excessive amounts of omega-6 in a form of linoleic acid residues (C18:2) and a very high ratio of linoleic acid residues (C18:2) to omega-3 in a form of α-linolenic acid residues (C18:3) ratio leads to the pathogenesis of many diseases, including cardiovascular disease, cancer, and inflammatory and autoimmune diseases, whereas increased levels of α-linolenic acid residues (C18:3) or reduced levels of linoleic acid residues (C18:2) (lower linoleic acid residues (C18:2)/α-linolenic acid residues (C18:3) ratio) may have suppressive effects. It is believed that the specific above weight ratio of linoleic acid residues (C18:2) to α-linolenic acid residues (C18:3) may prevent or have a beneficial effect on diseases such as cardiovascular diseases, breast cancers, inflammation in patients with autoimmune disease, colorectal cancer or asthma.

The fat composition preferably comprises a high amount of stearic acid. For example, the fat composition comprises from 10% to 40% by weight stearic acid (C18:0); preferably from 20% to 40% by weight stearic acid (C18:0) and advantageously from 20% to 30% by weight stearic acid (C18:0). This is advantageous from a nutritional perspective since stearic acid has a neutral effect upon total cholesterol.

In one embodiment, the fat composition comprises from 2 to 35% by weight of linoleic acid residues (C18:2); preferably from 2 to 30% by weight of linoleic acid residues (C18:2); more preferably from 2 to 25% by weight of linoleic acid residues (C18:2); and advantageously from 2 to 20% by weight of linoleic acid residues (C18:2).

In one embodiment, the fat composition comprises from 5 to 10% by weight of linoleic acid residues (C18:2). Alternatively, the fat composition comprises from 13 to 18% by weight of linoleic acid residues (C18:2).

In one embodiment, the fat composition comprises from 1 to 10% by weight of α-linolenic acid residues (C18:3). Preferably, the fat composition comprises from 1 to 8% by weight of α-linolenic acid residues (C18:3); and more preferably, from 1 to 5% by weight of α-linolenic acid residues (C18:3); such as from 1 to 3% by weight of α-linolenic acid residues (C18:3).

In one embodiment, the fat composition comprises less than 5% by weight of trans-fatty acids; preferably, less than 3% by weight of trans-fatty acids; more preferably, less than 1% by weight of trans-fatty acids. As recognized by the World Health Organization and the European Food Safety Organization, intake of trans-fatty acids should be very low to avoid any negative impact on health.

In one embodiment, the fat composition has:
(i). a solid fat content (SFC) N40 of less than 10, measured on unstabilised fat according to ISO 8292-1, preferably from 0 to 9, and more preferably from 0 to 7;
(ii). a solid fat content (SFC) N20 of from 10 to 60, preferably from 10 to 45, more preferably from 10 to 30, as measured on the unstabilised fat according to ISO 8292-1; and/or
(iii). a solid fat content (SFC) N30 of from 1 to 35, preferably from 1 to 20; more preferably from 1 to 15, as measured on the unstabilised fat according to ISO 8292-1.

Preferably, the fat composition has all three of the above properties.

Typically, the fat composition comprises from 5 to 35 percent by weight of CN46 and CN48 triglycerides, preferably from 10 to 30 percent by weight of CN46 and CN48 triglycerides. The abbreviation CN stands for the total carbon number of the fatty acid moieties present in the triglyceride molecule. For example, a triglyceride comprising two stearic acid residues and one lauric acid residue would have a total carbon number of 48.

Typically, the fat composition comprises from 0.3 to 9 percent by weight of St2M triglycerides, preferably from 2 to 9, and more preferably from 2 to 5, percent by weight of St2M triglycerides. Without being limited by theory, it has been found that fat compositions comprising St2M triglycerides in the amounts specified above aids in providing both the plasticized fat structure effect and the solid brittle structure marbling effect described above. The St2M triglycerides crystallise fast and bind oil well which aids in the provision of the effects discussed above.

The fat composition may be made from naturally occurring or synthetic fats, fractions of naturally occurring or synthetic fats, or mixtures thereof, that satisfy the requirements for fatty acids and triglyceride compositions discussed above. Preferably, the fat composition is derived from a blend of naturally occurring fats.

In one embodiment, the fat composition comprises an interesterified fat, and more preferably wherein the fat composition comprises an interesterified fat blend. The interesterified fat or interesterified fat blend may be produced by chemical interesterification, enzymatic interesterification, or a combination thereof.

In some embodiments, the interesterified fat or interesterified fat blend is produced by an enzymatic interesterification reaction which does not reach an equilibrium product distribution. It has been found that these embodiments provide a fat composition product with optimum properties for use in a meat analogue composition, such as the properties discussed above.

Processes for the preparation of the fat compositions such as the interesterification reactions discussed above are known in the art, and are discussed in, for example, Dijkstra, A. J. Interesterification. In: The Lipids Handbook 3rd Edition, pages 285-300 (F. D. Gunstone, J. L. Harwood, and A. J. Dijkstra (eds.), Taylor & Francis Group LLC, Boca Raton, FL) (2007).

In preferable embodiments, the fat composition comprises an interesterified fat blend (i) and a blending oil (ii).

Preferably, the fat composition comprises an interesterified fat blend (i) comprising a vegetable oil high in stearic acid and a vegetable oil high in lauric acid. Preferably, the vegetable oil high in stearic acid is also high in monounsaturated fatty acids such as oleic acids. Accordingly, in typical embodiments, the fat composition comprises an interesterified fat blend (i) comprising at least one fat selected from shea butter, shea stearin, shea olein, cocoa butter, cocoa stearin, cocoa olein, allanblackia fat, kokum fat, mango kernel fat, sal fat, illipe butter, and mixtures thereof; and at least one oil selected from coconut oil, coconut oil stearin, coconut oil olein, palm kernel oil, palm kernel olein, palm kernel stearin, babassu oil, and mixtures thereof.

Preferably, the blending oil (ii) is selected from: rapeseed oil, soybean oil, linseed oil, algae oil, or any combination thereof.

In one or more embodiments, the at least one interesterified fat blend (i) and the at least one blending oil (ii) are independently from each other fermented.

In highly preferred embodiments, the fat composition comprises a blend of (i) from 10% to 95% by weight of an interesterified blend of from 10% to 90% by weight of shea butter and/or shea stearin and from 10% to 90% by weight of coconut oil; and (ii) from 5% to 90% by weight of rapeseed oil. Preferably, the fat composition comprises a blend of (i) from 20% to 80% by weight of an interesterified blend of from 20% to 80% by weight of shea butter and/or shea stearin and from 20% to 80% by weight of coconut oil; and (ii) from 20% to 80% by weight of rapeseed oil. More preferably, the fat composition comprises a blend of (i) from 40% to 90% by weight of an interesterified blend of from 50% to 80% by weight of shea butter and/or shea stearin and from 20% to 50% by weight of coconut oil; and (ii) from 10% to 60% by weight of rapeseed oil. For example, the fat composition comprises a blend of (i) from 70% to 90% by weight of an interesterified blend of from 60% to 80% by weight of shea butter and/or shea stearin and from 20% to 40% by weight of coconut oil; and (ii) from 10% to 30% by weight of rapeseed oil.

Alternatively, the fat composition comprises a blend of (i) from 10% to 95% by weight of an interesterified blend of from 10% to 90% by weight of shea butter and/or shea stearin and from 10% to 90% by weight of coconut oil; and (ii) from 5% to 90% by weight of soybean oil. Typically, the fat composition comprises a blend of (i) from 20% to 80% by weight of an interesterified blend of from 20% to 80% by weight of shea butter and/or shea stearin and from 20% to 80% by weight of coconut oil; and (ii) from 20% to 80% by weight of soybean oil. For example, the fat composition comprises a blend of (i) from 40% to 90% by weight of an interesterified blend of from 50% to 80% by weight of shea butter and/or shea stearin and from 20% to 50% by weight of coconut oil; and (ii) from 10% to 60% by weight of soybean oil. The fat composition may comprise a blend of (i) from 70% to 90% by weight of an interesterified blend of from 60% to 80% by weight of shea butter and/or shea stearin and from 20% to 40% by weight of coconut oil; and (ii) from 10% to 30% by weight of soybean oil.

Preferably, the fat composition is present in the meat analogue composition in an amount of from 2 to 50% by weight of the meat analogue composition, preferably from 2 to 40% by weight of the meat analogue composition, more preferably from 2 to 30% by weight of the meat analogue composition, advantageously from 5 to 20% by weight of the meat analogue composition, such as from 7.5 to 20% by weight of the meat analogue composition.

Alternatively, the fat composition is present in the meat analogue composition in an amount of from 50 to 80% by weight of the meat analogue composition, preferably from 50 to 65% by weight of the meat analogue composition or from 65 to 80% by weight of the meat analogue composition.

The meat compositions of the invention comprise one or more non-animal proteins, such as one or more proteins derived from fungi, plants, microbial strains or a combination thereof.

Typically, the non-animal protein comprises plant protein. Preferably, the plant protein is selected from algae protein, black bean protein, canola wheat protein, chickpea protein, fava protein, lentil protein, lupin bean protein, mung bean protein, oat protein, pea protein, potato protein, rice protein, soy protein, sunflower seed protein, wheat protein, white bean protein, and protein isolates or concentrates thereof. Alternatively or additionally, the non-animal protein may also comprise seitan, rice protein, mushroom protein, legume protein, tempeh, yam flour, tofu, mycoprotein, peanut flour, yuba, or a combination thereof. Alternatively or additionally, the non-animal protein may also comprise methylococcus, hydrogenotropic bacteria, Heme-containing protein, or a combination thereof.

More preferably, the non-animal protein comprises texturized vegetable proteins, preferably wherein the texturized vegetable proteins comprise texturized pea proteins, texturized fava proteins, texturized soy proteins, texturized wheat proteins or a combination thereof. Preferably, the texturized vegetable protein is present in the meat analogue composition in an amount of from 10% to 20% by weight of the meat analogue composition.

The non-animal protein is present in the meat analogue composition in an amount of from 5% to 30% by weight of the meat analogue composition. Preferably, the non-animal protein is present in the meat analogue composition in an amount of from 5% to 25% by weight of the meat analogue composition, more preferably from 5% to 20% by weight of the meat analogue composition and advantageously from 5% to 15% or from 10 to 20% by weight of the meat analogue composition, such as from 10% to 15% by weight of the meat analogue composition.

Plant protein is a source of protein which is obtained or derived from plants. The plant protein may be any suitable plant protein and may comprise a mixture of plant proteins and/or may include protein isolates or concentrates. Examples of suitable plant proteins include those discussed above. As discussed above, preferably, the plant protein comprises textured vegetable proteins (TVP). TVPs are extruded proteins, which may be either dry or moist (i.e. hydrated), and which may be produced by low-moisture extrusion, high-moisture extrusion or other technologies. TVP is widely available and may be made from plant sources as mentioned above, such as soy flour or concentrate. In dry form, TVP can comprise up to about 70 wt. % of protein, typically about 60 to 70 wt. % of protein, and when hydrated comprises typically about 10 to 20 wt. % of protein. Typically, when hydrated TVPs can contain up to 3 to 4 times their dry weight in water. As discussed above, the weight percentage ranges referred to above for water present in the meat analogue compositions include both water added in its own right and water present in other components of the meat analogue composition such as in textured vegetable proteins or emulsified with fat. Similarly, the weight percentage ranges given above for the amount of non-animal protein present in the meat analogue composition refer to dry weight of protein, and do not include water bound to the non-animal protein such as in textured vegetable protein.

The plant protein used in the preparation of the meat-analogue composition may be either dry (also referred to as ‘dry phase’ herein) or moist. Thus, the plant protein may be included in a dry mix of ingredients, which may include additional ingredients intended for inclusion in the meat-analogue composition, such as carbohydrates, fibre and/or hydrocolloids, in addition to protein. If the plant protein is dry, it may be hydrated prior to and/or during the formation of the meat-analogue composition. The term ‘dry’ used in relation to the plant protein and ‘dry phase’ used herein, is intended to mean that the phase comprising plant protein comprises less than 10 wt. % water, less than 5 wt. % water, preferably less than 2 wt. % water, more preferably less than 1 wt. % water, even more preferably that it is substantially free from water. In other examples, the water activity (aw) of the dry phase is 0.90 or lower, more preferably below 0.80. The dry phase comprising plant protein is typically provided in a substantially dehydrated state to reduce microbial growth as far as possible so as to extend shelf life.

The meat-analogue composition comprises water, which may be added as a separate component to the composition, or derive from other components of the composition as discussed above. The amount of water is not particularly limited and, as the skilled person will appreciate, will vary depending on the intended consistency of the meat-analogue composition. Reference to ‘water’ herein is intended to include drinking water, demineralized water or distilled water, unless specifically indicated. As the skilled person will appreciate, deionized water is also a sub-class of demineralized water. Typically, the water is present in the meat analogue composition in an amount of from 20% to 70% by weight of the meat analogue composition, such as from 30% to 70% by weight.

The meat analogue composition typically comprises one or more additional ingredients. Whilst these one or more additional ingredients may be preferable to include in the meat analogue compositions, it will be understood that the inclusion of the one or more additional ingredients is not essential.

The meat analogue composition preferably further comprises a stabilizer blend. Typically, the stabilizer blend is present in an amount of from 2% to 20% by weight of the meat analogue composition. Preferably, the stabilizer blend is present in the meat analogue composition in an amount of from 5% to 10% by weight of the meat analogue composition. Typically, the stabilizer blend comprises vegetable derived protein, vegetable fibre and/or a polysaccharide.

Preferably, the vegetable derived protein comprises pea protein, the vegetable fibre comprises pea fibre, and/or the polysaccharide comprises methylcellulose.

Most preferably, the stabilizer blend comprises vegetable derived protein comprising pea protein, vegetable fibre comprising pea fibre, and polysaccharide comprising methylcellulose.

The meat analogue composition may comprise one or more flavouring additives. Preferably, the one or more flavouring additives are present in an amount of from 0.5% to 5% by weight of the meat analogue composition. Suitable flavouring additives known in the art may be used in the meat analogue compositions.

The meat analogue composition may comprise one or more colouring additives. Preferably, the one or more colouring additives are present in an amount of from 0.5% to 5% by weight of the meat analogue composition. Suitable colouring additives known in the art may be used in the meat analogue compositions.

The meat analogue composition may further comprise one or more of: i) polysaccharides and/or modified polysaccharides, preferably selected from methylcellulose, hydroxypropyl methylcellulose, carboxymethyl cellulose, maltodextrin, carrageenan and salts thereof, alginic acid and salts thereof, agar, agarose, agaropectin, pectin and alginate; ii) hydrocolloids; and iii) gums, preferably selected from xanthan gum, guar gum, locust bean gum, gellan gum, gum arabic, vegetable gum, tara gum, tragacanth gum, konjac gum, fenugreek gum, and gum karaya.

Examples of other additives that may be included in the meat analogue composition further comprises an ionic or non-ionic emulsifier, a polyhydroxy compound, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, starch, salt, spices, fibre, flavour components, colourants, thickening and gelling agents, egg powder, enzymes, gluten, vitamins, preservatives, sweeteners, oxidising agents, reducing agents, anti-oxidants, and acidity regulators.

Preferably, the meat analogue is suitable for consumption by vegetarians and vegans. Accordingly, the meat analogue composition may be substantially free of animal protein, and more preferably, the meat analogue composition is free of animal protein.

Preferably, the meat analogue composition is substantially free of animal-derived products, and more preferably, the meat analogue composition is free of animal-derived products.

However, alternatively, the meat analogue compositions may comprise animal-derived products such as animal derived proteins or fats. Accordingly, the meat analogue composition may further comprise one or more animal-derived products such as animal oils, marine oils, animal-derived proteins, animal-derived polysaccharides, or any combination thereof. The one or more animal-derived products may comprise animal milk proteins, animal milk fats, or a combination thereof. Thus, the meat analogue compositions may be suitable for consumption by vegetarians on the basis that they comprise nonanimal protein and proteins or fats derived from animal milk. These meat analogue compositions are suitable for consumption by vegetarians since they do not include fats or proteins derived from meat. However, it will of course be understood that such meat analogue compositions are not suitable for consumption by vegans.

Where the meat analogue compositions comprise one or more animal-derived products, the one or more animal-derived products are typically present in the meat analogue composition in an amount of from 1% to 20% by weight of the meat analogue composition, such as from 1% to 10% by weight of the meat analogue composition.

According to a second aspect of the invention, there is provided a food product comprising a meat analogue composition of the invention. The food product may be an uncooked food product, a cooked food product, or a partially cooked food product.

Typically, the food product is a vegetarian or vegan substitute food product. Preferably, the vegetarian or vegan substitute food product is a meat food product or a seafood product. Preferably, the meat food product is a cut of meat, fish meat, burger, sausage, pepperoni, meat ball, nugget, patty, mince product, meatloaf, bacon, steak, whole muscle, cold cuts, or other product intended to mimic conventional meat-based food products. In another preferred embodiment, the seafood food product is a calamari analogue product; crustacean product such as a prawn analogue product, a lobster analogue product, a crab analogue product, a crabstick analogue product, a scampi analogue product; or a fish analogue product such as a fish cake or a fish filet; or other product intended to mimic conventional seafood-based food products.

According to a third aspect of the invention, there is provided the use of a meat analogue composition according to the invention in a food product.

Preferably, the use comprises using the fat composition to improve the nutritional profile of the meat analogue composition when compared to an analogous meat analogue composition comprising the same amount by weight of coconut oil and/or an analogous meat analogue composition comprising the same amount by weight of a blend comprising (a) an interesterified blend of shea butter and/or shea stearin and coconut oil; and (b) sunflower oil. The term analogous meat analogue composition as used herein is used to refer to an equivalent weight of a meat analogue composition that is identical to the meat composition of the invention, with the exception of the nature of the fat present therein. The analogous meat analogue composition contains the same amount by weight of coconut oil as the meat analogue composition of the invention contains the fat composition. The nutritional profile of the meat analogue composition of the invention may be improved in comparison to coconut oil since it contains a lower total amount of saturated fatty acid residues per unit weight than coconut oil.

Coconut oil contains around 90% saturated fatty acid residues. Without being limited by theory, it is believed that fats with higher saturated fatty acid contents increase the risk of heart disease, high blood pressure and associated conditions, and also have a detrimental effect upon the cholesterol levels of consumers. Accordingly, the use comprises using the fat composition to improve the effect on in vivo cholesterol levels in a consumer of the meat analogue composition when compared to an analogous meat analogue composition comprising the same amount by weight of coconut oil. Alternatively or in addition, the nutritional profile of the meat analogue composition of the invention may be improved in comparison to a blend comprising (a) an interesterified blend of shea butter and/or shea stearin and coconut oil; and (b) sunflower oil, since it contains a higher total amount of α-linolenic acid residues per unit weight than said interesterified blend.

The use may comprise using the fat composition to provide improved mouthfeel from the meat analogue composition when cooked when compared to an analogous meat analogue composition comprising the same amount by weight of coconut oil, and/or an analogous meat analogue composition comprising the same amount by weight of sunflower oil. Without being limited by theory, the mouthfeel compared to sunflower oil is believed to be due to the fat compositions having a higher solid fat content at a temperature of at least 25° C., such as at a mouth temperature of about 30° C. Many flavours and flavouring additive compounds are fat soluble and so are dissolved within the fat of the meat analogue composition. With a higher solid fat content, the sensation of having a greasy coating on the tongue and surfaces of the mouth can be felt, as well as a delayed release of flavours from the fat over a longer period of time. The mouthfeel is believed to enable the meat analogue composition to more closely resemble the mouth feel and delayed flavour release of meat, which contains higher melting point fats which typically have higher solid fat contents at a temperature of at least 25° C.

The use may comprise using the fat composition to provide improved juiciness of the meat analogue composition when cooked when compared to an analogous meat analogue composition comprising the same amount by weight of coconut oil, and/or an analogous meat analogue composition comprising the same amount by weight of sunflower oil. Improved juiciness of the meat analogue composition or a cooked food product comprising the composition is also believed to make the meat analogue composition more closely resemble the mouthfeel, juiciness and succulence of meat products.

The use may comprise using the fat composition to provide improved processability to the meat analogue composition when compared to an analogous meat analogue composition comprising the same amount by weight of coconut oil, and/or an analogous meat analogue composition comprising the same amount by weight of sunflower oil. Improved processability and handleability is provided, for example, by the fat compositions keeping their structure and thereby reducing problems with too oily meat doughs when forming or packaging at the end consumer. Additionally, the fat composition may be processed and mixed with other components without melting, i.e., without the need of extra energy. Thus, the other components of the meat analogue composition do not suffer from a large temperature increase avoiding a microbial growth increase and a reduction of the hydration of certain components.

According to a fourth aspect of the invention, there is provided a process of manufacturing a meat analogue composition of the invention or a food product of the invention.

Preferably, there is provided a process of manufacturing a meat analogue composition according to the invention, or a food product according to the invention, wherein the process comprises:
A). providing a mixture of water and non-animal protein;
B). combining the mixture from step (a) with the fat composition and optionally one or more additional components to form the meat analogue composition; and
C). optionally forming the meat analogue composition into food products.

Preferably, the process further comprises cooking the food product to form a cooked food product or partially cooked food product.

Preferably, the fat composition is not melted prior to combining with the mixture from step (a) and optionally one or more additional components.

Whilst the above-described steps are preferable steps for manufacturing the meat analogue compositions or food products described herein, it will be appreciated that other suitable processes may also be used to manufacture the meat analogue compositions and food products.

The meat-analogue composition of the present invention may be readily prepared by blending a fat composition as described herein with plant protein and any other components of the composition. By way of example, a process for preparing a meat analogue composition may comprise the step of forming the meat-analogue composition by blending a plant protein with a fat composition as described herein. Optionally, further ingredients may be present. Water may be added to the composition if required at any stage during the process. The process may further comprise the step of preparing the plant protein by providing a dry phase comprising plant protein and blending the dry phase with an amount of water, which precedes the step of forming the meat-analogue composition. This step may also include other ingredients which are in dry form, such that these dry ingredients are hydrated simultaneously with the plant protein. Additionally, and/or alternatively, any other dry ingredients may be hydrated separately from the plant protein in any combination. Where TVPs are included, the TVP is preferably hydrated separately from any other dry ingredients. Without being bound by theory, this is believed to limit competition between the dry components for the water and ensure satisfactory hydration for all dry components present.

Thus, disclosed herein is a process for preparing a meat-analogue composition, said process comprising the steps of: a) providing a dry phase comprising plant protein and optionally any other dry ingredients of the composition and blending the dry phase with an amount of water to form a mixture; b) forming the meat-analogue composition by blending the mixture formed in step a) with a fat composition as described herein. The plant protein may comprise TVPs. Preferably, dry ingredients other than the TVP are hydrated separately from the TVP. Examples of such dry ingredients include, but are not limited to, fibres, flavours, emulsifiers, gums, hydrocolloids, thickeners, plant protein isolate and powdered colourants. Preferably, the mixture of step a) comprising the hydrated plant protein and any other mixtures comprising hydrated dry ingredients are combined prior to step b). Without being bound by theory, it is believed that the hydration of dry ingredients prior to the addition of the fat composition (for example, in step a)) results in an optimal distribution of water in the product, resulting in a more stable meat-analogue composition.

The dry phase comprising plant protein used in the above process is not particularly limited. The plant protein is as described hereinabove. The term ‘dry phase’ is intended to mean that the phase comprising plant protein comprises less than 10% water, such as less than 5 wt. % water, preferably less than 2 wt. % water, more preferably less than 1 wt. % water, even more preferably that it is substantially free from water. The aw of the dry phase may be 0.90 or lower, more preferably below 0.80. The dry phase comprising plant protein is typically provided in a substantially dehydrated state to reduce microbial growth as far as possible so as to extend shelf life.

The dry phase, which may comprise plant protein, may take any physical form before being blended with water, however typically it is in powder, granule or pelletized, strip or chunk form.

The amount of water added to the dry phase is not particularly limited. Typically, an amount of water is added in order to bind the dry components into a paste or dough with which the fat composition may be readily blended. The amount of water added to the dry phase is preferably calculated such that the total amount of water in the meat-analogue composition after addition of the other components of the fat composition are within the ranges described above.

The temperature of the water added is not particularly limited, so long as it does not materially impact the intended characteristics of the components (e.g. does not lead to protein denaturation or hydrolysis). Preferably, the water is below room temperature (i.e. below 20° C.). More preferably, ice water is used. This is particularly preferred when water is added to the dry phase. The term “ice water” is defined herein as having a temperature of above 0° C. and below 6° C., preferably from 0.5 to 5° C., more preferably from 1 to 4° C., more preferably from 1 to 3° C. An advantage of using ice water is that it slows microbial growth as far as possible during preparation of the meat-analogue composition and it is particularly suitable for the hydration of certain dry ingredients as methylcellulose.

The blending of the dry phase with water may be performed for any duration of time. For example, blending may be performed until the dry phase and water are intimately mixed and typically until a paste or dough is formed. Where TVPs are hydrated, blending is limited to a minimum so as not to overly disturb the fibrous structures. Preferably, this may be performed for a duration of from 1 second to 30 minutes, preferably from 1 second to 10 minutes, more preferably from 5 seconds to 5 minutes.

Following blending of the dry phase and water, for example in step a), the mixture may be allowed to rest prior to the addition of the fat composition, for example in step b). This may ensure full hydration of the dry phase prior to addition of the fat composition. This rest may be performed under cold storage (thereby further controlling microbial growth), which has a temperature of from 0.5 to 15° C., preferably from 1 to 12° C., more preferably from 5 to 10° C. This rest may be performed for a duration of from 5 minutes to 24 hours, for example from 5 minutes to 5 hours, preferably from 5 minutes to 2 hours, more preferably from 5 minutes to 30 minutes.

Preparation of the meat-analogue composition may also comprise the step of adding further ingredients to the composition. These ingredients may be added at any stage in the preparation of the meat-analogue composition. By way of example, further ingredients may be added after the addition of the fat composition, for example after step b). Preferably, dry ingredients are hydrated prior to addition to the fat composition. By way of further example, dry ingredients may be hydrated with any dry plant protein, such as in step a), prior to the addition of the fat composition. Such ingredients may include one or more of additives as disclosed in more detail herein. The addition of these ingredients may be performed by blending, mixing or any suitable means.

Once the meat-analogue composition has been prepared, this may be formed into a food product. This may include the step of forming the meat-analogue composition into the desired shape. The shape and size of the resulting food product is not particularly limited.

Examples of shaped food products which can be made from the meat-analogue composition according to the present invention include burgers, sausages, nuggets, meatballs and mince.

Any suitable method may be used to shape the meat-analogue composition into the desired shape. By way of example, this may be performed by cutting, moulding, pressing, extrusion, rolling, grinding or any combination thereof. These processes may be performed using an apparatus, which may be operated manually or may be automated. The meat-analogue composition may be compressed for few seconds to few hours. The duration and pressure of compression is determined by the desired properties of the resulting food product, such as its size and density, taking into account the properties of the meat-analogue composition, such as adhesiveness, among other factors. This may form the desired shape of the food product, or it may be further processed such as by pelletizing, grinding or cutting, for instance to replicate the attributes of ground/minced meat.

The process of preparing a meat-analogue composition may further comprise cooking or part-cooking the composition, which may have been formed into a food product. Cooking may comprise boiling, baking, frying and/or microwaving. Preferably, cooking is at sufficient temperature such that the Maillard reaction may occur (for example, above 80° C. and up to 180° C., preferably from 130° C. to 170° C.). The Maillard reaction is useful for desirable browning of the food product.

### EXAMPLES

The following examples are for illustrative purposes only, and are not intended to limit the scope of the invention in any way.

### Example 1

Comparative Fat A is sunflower oil.

Comparative Fat B is coconut oil.

Comparative Fat C comprises (i) 78% of an interesterified blend including 70 wt % shea butter and 30 wt % coconut oil and (ii) 22 wt. % of sunflower oil.

Comparative Fat D comprises (i) 78% of an interesterified blend including 70 wt % shea butter and 30 wt % coconut oil and (ii) 22 wt. % of high oleic sunflower oil.

Fat E comprises (i) 78% of an interesterified blend including 70 wt % shea butter and 30 wt % coconut oil and (ii) 22 wt. % of rapeseed oil.

Various properties of Fat E are shown in Table 1 below and contrasted against comparative fats.

TABLE 1

| Fatty acid | Compara- | | | | |
|---|---|---|---|---|---|
| residue | tive Fat A | Compara- | Compara- | Compara- | |
| concentrations | sunflower | tive Fat B | tive | tive | |
| (wt %) | oil | coconut oil | Fat C | Fat D | Fat E |
| C6:0 | 0.0 | 0.6 | 0.2 | 0.2 | 0.2 |
| C8:0 | 0.0 | 7.4 | 2.0 | 2.0 | 2.0 |
| C10:0 | 0.0 | 5.8 | 1.6 | 1.6 | 1.6 |
| C12:0 | 0.0 | 46.4 | 11.0 | 11.0 | 11.0 |
| C14:0 | 0.0 | 18.8 | 4.2 | 4.1 | 4.1 |
| C16:0 | 6.4 | 9.4 | 5.2 | 4.6 | 4.8 |
| C16:1 | 0.1 | 0.0 | 0.0 | 0.0 | 0.0 |
| C17:0 | 0.0 | 0.0 | 0.1 | 0.1 | 0.1 |
| C17:1 | 0.0 | 0.0 | 0.0 | 0.0 | 0.0 |
| C18:0 | 3.6 | 3.0 | 25.0 | 24.9 | 24.5 |
| C18:1 | 30.8 | 6.7 | 32.8 | 44.4 | 39.8 |
| C18:2 | 56.7 | 1.8 | 16.6 | 5.7 | 8.1 |
| C18:3 | 0.1 | 0.0 | 0.1 | 0.1 | 2.2 |
| C20:0 | 0.3 | 0.0 | 0.1 | 0.1 | 0.2 |
| C20:1 | 0.3 | 0.0 | 0.3 | 0.3 | 0.5 |
| C20:2 | 0.0 | 0.0 | 0.0 | 0.0 | 0.0 |
| C22:0 | 0.8 | 0.0 | 0.3 | 0.3 | 0.1 |
| C22:1 | 0.1 | 0.0 | 0.0 | 0.0 | 0.1 |
| C22:2 | 0.0 | 0.0 | 0.0 | 0.0 | 0.0 |
| C24:0 | 0.3 | 0.0 | 0.1 | 0.1 | 0.1 |
| C24:1 | 0.0 | 0.0 | 0.0 | 0.0 | 0.0 |
| SAFA | 11.4 | 91.5 | 49.4 | 48.7 | 48.5 |
| C18:2/C18:3 | 567 | >40 | 166 | 57 | 3.7 |

It can also be seen that Fat E has a lower saturated fatty acid residue content than coconut oil. Furthermore, the ratio of linoleic acid residues (C18:2) to α-linolenic acid residues (C18:3) of Fat E further improves the nutritional value of Fat E compared to all comparative fats, notably by preventing or having a beneficial effect on certain diseases as discussed above.

### Example 2

### General Method for Preparation of Plant-Based Burgers

Burgers were made from meat analogue compositions comprising Fat E (i.e. meat analogue compositions according to the invention), and from meat analogue compositions comprising Comparative Fat C.

The following procedure was used for the preparation of the plant-based burgers of the following examples:
1. The texturized proteins++ were hydrated with cold water (5° C.) according to the quantities shown in Table 2 and further hydrated for 30 minutes in cold storage (5° C.).
2. All other ingredients in powder form (stabilizer blend+++ and flavours) were mixed and hydrated with ice water (1-3° C.) by blending for at least 1 minute, following which they were stored in a fridge (5° C.) for at least 30 minutes;
3. The proteins were chopped for 20 seconds at low speed;
4. The ingredients from steps 2 and 3 and any further ingredients (e.g. colours, fats in molten form) according to the quantities shown in Table 2 were combined and the resulting dough blended for about 2 minutes;
5. The dough was rested in a fridge (operating at a temperature of 5° C.) for at least 30 minutes;
6. Burgers (65 g) were made from this dough and stored in the Fridge at 4° C.
7. Samples were cooked by heating on a Clamshell cooker until they reached an internal core temperature of 65° C.
++ The texturized proteins referred to above are textured pea proteins (protein content minimum 70%; format: strips)+
+++ The stabilizer blend referred to above is a blend of pea proteins (protein content minimum 83%; format: powder), fiber concentrate of chia seed and methylcellulose.

The compositions of the burgers of Comparative Example 1 and Example 2 are prepared according to the above method and are shown below in Table.

TABLE 2

| | Comparative | |
|---|---|---|
| | Sample 1 | Sample 2 |
| Water (X° C.) (%) | 39.7 | 39.7 |
| Texturized proteins⁺⁺ | 16 | 16 |
| (%) | | |
| Comparative Fat C | 11.7 | 0 |
| (%) | | |
| Fat E (%) | 0 | 11.7 |
| Stabilizer blend⁺⁺⁺ | 8.5 | 8.5 |
| (%) | | |
| Ice water (1-3° C.) (%) | 23 | 23 |
| Flavours (%) | 1.1 | 1.1 |

### Properties of the Burgers of the Examples

The hardness and the chewiness of the burgers were measured by TPA using the following method:

Texture profile analysis (TPA) was used to determine the hardness, defined as the maximum peak force during the first compression cycle (first bite) which has often been substituted by the term firmness, and the chewiness, defined as the product of gumminess×springiness (hardness×cohesiveness×springiness). TPA was performed on a TA.XT₂ machine (by Stable Micro Systems) fitted with a 50 kg load cell and a 50 mm diameter metal probe. The machine was programmed to run with the following settings: pre-test speed: 3 mm/s; test speed: 2 mm/s; post-test speed: 5 mm/s; compression: 60%; time between cycles: 5 s; trigger type: automatic on 0.49 N; data acquisition rate: 200 pps. The test material was thawed air-tight at 5° C., tempered air-tight in a cabinet of 20° C. and from the middle of the sample strips squared pieces of 2 cm×2 cm were cut out before analysis. The test material was compressed two times in a reciprocating motion, mimicking the chewing movement in the mouth. A Force versus Time (and/or distance) graph was obtained, from which the desired information was obtained. TPA and the classification of textural characteristics is described further in Bourne M. C., Food Technol., 1978, 32 (7), 62-66 and Trinh T. and Glasgow S., ‘On the texture profile analysis test’, Conference Paper, Conference: Chemeca 2012, Wellington, New Zealand, and may be performed as described therein. The results given in Table 3 are based on the average of 6 measurements.

Texture profile analysis (TPA) was used to determine the firmness, defined as the maximum peak force during the first compression cycle. TPA was performed on a TA.XT₂ machine (by Stable Micro Systems) fitted with a 50 kg load cell and a knife blade probe (code HDP/BS). The machine was programmed to run with the following settings: pre-test speed: 3 mm/s; test speed: 2 mm/s; post-test speed: 5 mm/s; compression %: 70%; trigger type: automatic on 0.49 N; data acquisition rate: 200 pps. The test material was thawed air-tight at 5° C., tempered air-tight in a cabinet of 20° C. and from the middle of the sample strips squared pieces of 2 cm×2 cm were cut out before analysis. The test material was compressed once, mimicking the first bite movement in the mouth. A Force versus Time (and/or distance) graph was obtained, from which the desired information was obtained. TPA and the classification of textural characteristics is described further in Bourne M. C., Food Technol., 1978, 32 (7), 62-66 and Trinh T. and Glasgow S., ‘On the texture profile analysis test’, Conference Paper, Conference: Chemeca 2012, Wellington, New Zealand, and may be performed as described therein. The results given in (Insert table)

The weight loss (%) was determined by weighing the sample prior to cooking and afterwards and calculating as follows:

$$Weight loss ( \% ) = \frac{Sample weight prior to cooking}{Sample weight after cooking} \times 100$$

The diameter loss (mm) was determined by measuring the sample prior to cooking and afterwards and calculating as follows:

$$Diameter loss ( \% ) = \frac{Sample diameter prior to cooking}{Sample diameter after cooking} \times 100$$

TABLE 3

| | | Comparative | |
|---|---|---|---|
| | | Sample 1 | Sample 2 |
| Hardness (g) | Before frying | 2655 | 2144 |
| | After frying | 7327 | 6169 |
| Chewiness (g) | Before frying | 525 | 469 |
| | After frying | 1449 | 1064 |
| Firmness (g) | Before frying | 628 | 648 |
| | After frying | 1821 | 1561 |
| weight loss (%) | After frying | 11 | 17 |
| diameter loss (mm) | After frying | 5.6 | 4.5 |

Sample 2 has a hardness and chewiness slightly lower than the hardness, firmness and chewiness of Sample 1 reflecting an improved tenderness. Furthermore, Sample 2 was easily processable when compared to Comparative Sample 1. In other words, Sample 2 did not stick to any equipment during the manufacture of the burgers. Sample 2 had a good cohesiveness and brittleness, i.e. Sample 2 did not fracture when subjected to pressure and had a tendency to deform.

### Example 3

Sensory Evaluation of the Burgers of the Examples after Frying

All the burgers were subjected to sensory evaluation. Seven testers were asked to compare Comparative Sample 1 with Sample 2 respectively, regarding juiciness, off flavour, oiliness and crumbling. The results were rated from 0 to 5. 0 means that the sensory requirement was not fulfil or very bad. 5 means that the sensory requirement was very good or very well achieved. The results of this evaluation are shown in Table 4.

TABLE 4

| Property | Comparative | |
|---|---|---|
| After Frying | Sample 1 | Sample 2 |
| Juiciness | 2.9 | 3.2 |
| Off flavour | 1.6 | 1.9 |
| Oiliness | 2.7 | 2.9 |
| Crumbling | 2.7 | 2.5 |

Sample 2 according to the invention scores highly on juiciness, off flavour, oiliness and crumbling.

1. A meat analogue composition comprising from 2% to 81% by weight of a fat composition; from 1% to 30% by weight of a non-animal protein; and from 18% to 70% by weight of water; wherein the fat composition comprises from 20% to 85% by weight of saturated fatty acid residues; from 5% to 50% by weight of stearic acid residues (C18:0); from 2 to 35% by weight of linoleic acid residues (C18:2); and from 1 to 15% by weight of α-linolenic acid residues (C18:3); from greater than 10 to 35% by weight of lauric acid residues (C12:0); wherein said percentages of fatty acid residues refers to fatty acids bound as acyl groups in glycerides in the fat composition and being based on the total weight of C6 to C24 fatty acid residues bound as acyl groups present in the fat composition.

2. The meat analogue composition according to claim 1, wherein the fat composition comprises from 20% to 70% by weight of saturated fatty acids.

3. The meat analogue composition according to claim 1, wherein the fat composition comprises less than 10% by weight of palm oil.

4. The meat analogue composition according to claim 1, wherein the fat composition comprises 20% by weight or less of palmitic acid (C16:0).

5. The meat analogue composition according to claim 1, wherein the fat composition has a weight ratio of stearic acid (C18:0) to palmitic acid (C16:0) of from 1:1 to 12:1.

6. The meat analogue composition according to claim 1, wherein the fat composition has a weight ratio of lauric acid (C12:0) to stearic acid (C18:0) of from 1:4 to 4:1.

7. (canceled)

8. The meat analogue composition according to claim 1, wherein the fat composition is a non-hydrogenated fat composition.

9. The meat analogue composition according to claim 1, wherein the fat composition comprises from greater than 10 to 30% by weight of lauric acid residues (C12:0).

10. The meat analogue composition according to claim 1, wherein the fat composition has a weight ratio of linoleic acid residues (C18:2) to α-linolenic acid residues (C18:3) of from 1:1 to 20:1.

11-12. (canceled)

13. The meat analogue composition according to claim 1, wherein the fat composition comprises from 10% to 40% by weight stearic acid (C18:0).

14. The meat analogue composition according to claim 1, wherein the fat composition comprises from 2 to 35% by weight of linoleic acid residues (C18:2).

15-16. (canceled)

17. The meat analogue composition according to claim 1, wherein the fat composition comprises from 1 to 10% by weight of α-linolenic acid residues (C18:3).

18. (canceled)

19. The meat analogue composition according to claim 1, wherein the fat composition comprises less than 5% by weight of trans-fatty acids.

20. The meat analogue composition according to claim 1, wherein:
(i) the fat composition has a solid fat content (SFC) N40 of less than 10, measured on unstabilised fat according to ISO 8292-1;
(ii) the fat composition has a solid fat content (SFC) N20 of from 10 to 60, as measured on the unstabilised fat according to ISO 8292-1; and/or
(iii) the fat composition has a solid fat content (SFC) N30 of from 1 to 35, as measured on the unstabilised fat according to ISO 8292-1.

21. The meat analogue composition according to claim 1, wherein the fat composition comprises from 5 to 35 percent by weight of CN46 and CN48 triglycerides.

22. The meat analogue composition according to claim 1, wherein the fat composition comprises from 0.3 to 9 percent by weight of St2M triglycerides.

23. The meat analogue composition according to claim 1, wherein the fat composition comprises an interesterified fat.

24. The meat analogue composition according to claim 23, wherein the interesterified fat has been produced by chemical interesterification, enzymatic interesterification, or a combination thereof.

25. The meat analogue composition according to claim 1, wherein the fat composition comprises an interesterified fat blend (i) and a blending oil (ii).

26. The meat analogue composition according to claim 1, wherein the fat composition comprises an interesterified fat blend (i) comprising at least one fat selected from shea butter, shea stearin, shea olein, cocoa butter, cocoa stearin, cocoa olein, allanblackia fat, kokum fat, mango kernel fat, sal fat, illipe butter, and mixtures thereof; and at least one oil selected from coconut oil, coconut oil stearin, coconut oil olein, palm kernel oil, palm kernel olein, palm kernel stearin, babassu oil, and mixtures thereof.

27. The meat analogue composition according to claim 25, wherein the blending oil (ii) is selected from: rapeseed oil, soybean oil, linseed oil, algae oil, or any combination thereof.

28. The meat analogue composition according to claim 27, wherein the at least one interesterified fat blend (i) and the at least one blending oil (ii) are independently from each other fermented.

29. The meat analogue composition according to claim 1, wherein the fat composition comprises a blend of (i) from 10% to 95% by weight of an interesterified blend of from 10% to 90% by weight of shea butter and/or shea stearin and from 10% to 90% by weight of coconut oil; and (ii) from 5% to 90% by weight of rapeseed oil.

30-32. (canceled)

33. The meat analogue composition according to claim 1, wherein the fat composition comprises a blend of (i) from 10% to 95% by weight of an interesterified blend of from 10% to 90% by weight of shea butter and/or shea stearin and from 10% to 90% by weight of coconut oil; and
(ii) from 5% to 90% by weight of soybean oil.

34-36. (canceled)

37. The meat analogue composition according to claim 1, wherein the fat composition is present in the meat analogue composition in an amount of from 2 to 50% by weight of the meat analogue composition.

38-51. (canceled)

52. The meat analogue composition according to claim 1, wherein the meat analogue composition is substantially free of animal protein.

53. The meat analogue composition according to claim 1, wherein the meat analogue composition is substantially free of animal-derived products.

54. The meat analogue composition according to claim 1, wherein the meat analogue composition further comprises one or more animal-derived products.

55. The meat analogue composition according to claim 54, wherein the one or more animal-derived products comprise animal milk proteins, animal milk fats, or a combination thereof.

56. The meat analogue composition according to claim 54, wherein the one or more animal-derived products are present in the meat analogue composition in an amount of from 1% to 20% by weight of the meat analogue composition.

57. A food product comprising a meat analogue composition according to claim 1.

58-68. (canceled)

69. A process of manufacturing a meat analogue composition according to claim 1, wherein the process comprises:
A). providing a mixture of water and non-animal protein;
B). combining the mixture from step (a) with the fat composition and optionally one or more additional components to form the meat analogue composition; and
C). optionally forming the meat analogue composition into food products.

70-71. (canceled)
